(19) United States
(12) Patent Application Publication
(10) Pub. No.: US 2017/0178013 A1
(43) Pub. Date: Jun. 22, 2017

(54) AUGMENTED REALITY RECOMMENDATIONS IN EMERGENCY SITUATIONS

(71) Applicant: INTERNATIONAL BUSINESS MACHINES CORPORATION, ARMONK, NY (US)

(72) Inventors: ANTON BELOGLAZOV, MOUNTAIN VIEW, CA (US); FERNANDO L. KOCH, FLORIANOPOLIS (BR); JAN RICHTER, BERLIN (DE); KENT C. STEER, BRUNSWICK VIC (AU)

(21) Appl. No.: 14/976,512

(22) Filed: Dec. 21, 2015

(51) Int. Cl. G06N 7/00; G06Q 50/26; G06T 19/00; G06Q 10/10

(52) U.S. Cl. CPC G06N 7/005; G06Q 10/10; G06Q 50/265; G06T 19/006; G06T 2219/012

(57) ABSTRACT

A method of providing augmented reality recommendations, includes notifying a user about an emergency situation, wherein the notification is provided to the user via a mobile device, and activating a software application on the mobile device to provide an augmented reality (AR) visualization of at least one current event, at least one predicted event and at least one action recommendation in relation to the emergency situation.

### BACKGROUND

The present invention relates to recommendations in emergency situations, and more specifically, to systems and methods for providing Augmented Reality (AR) recommendations in emergency situations.

AR technology generally includes images along with annotations of features or objects displayed on the image. The AR images may be photographs or computer-generated images of an area of interest. The area of interest may be a city including buildings and roads, a park, a rural area, or the like. The annotations may identify the features or objects included in the AR image. For example, an annotation may include text such as “Empire State Building” and an arrow pointed to the Empire State Building.

### SUMMARY

According to an exemplary embodiment of the present invention, a method of providing augmented reality recommendations includes notifying a user about an emergency situation, wherein the notification is provided to the person via a mobile device, and activating a software application on the mobile device to provide an augmented reality (AR) visualization of at least one current event, at least one predicted event and at least one action recommendation in relation to the emergency situation.

In an exemplary embodiment of the present invention, the AR visualization is provided on top of a four-dimensional view of an area around the user.

In an exemplary embodiment of the present invention, the mobile device includes a smartphone or a wearable device.

In an exemplary embodiment of the present invention, wherein in response to activating the software application, the method further includes, requesting a remote AR service to provide information including observed and inferred events, predicted events in the area, global context, and recommendations.

In an exemplary embodiment of the present invention, the observed and inferred events are included in a repository of observed and inferred events, the repository including a set of events collected from other sources or analytical models, wherein each event is represented by tuple time ≦current time, geolocation coordinates, prediction level confidence, event type and degree.

In an exemplary embodiment of the present invention, the predicted events in the area are included in a repository of predicted events, the repository including a set of future events computed by a situation simulator, wherein each event is represented by a tuple<time, location, certainty, type, parameters>, where time is greater than current time, location is geolocation coordinates, certainty is the prediction level confidence, type is the event type and degree.

In an exemplary embodiment of the present invention, the situation simulator infers the set of future events based on computation guided by models of the world and the set of events in the repository of observed and inferred events.

In an exemplary embodiment of the present invention, a context engine computes the global context based on a local context included in the request, the global context including a set of related and predicted events in the area near the user.

In an exemplary embodiment of the present invention, a recommendation engine computes the recommendations based on the local context and the global context, data from the repository of observed and inferred events and data from the repository of predicted events.

In an exemplary embodiment of the present invention, the recommendations includes a set of recommendations for best actions in the area near the user.

In an exemplary embodiment of the present invention, the action recommendation includes route guidance to a location of the emergency situation, or route guidance to a location away of the emergency situation.

In an exemplary embodiment of the present invention, the action recommendation is based on a local context of the user.

In an exemplary embodiment of the present invention, the local context is determined personal information of the user obtained from the mobile device.

According to an exemplary embodiment of the present invention, a system for providing AR recommendations includes an operation unit configured to receive data from external sources to determine observed and inferred events and store the observed and inferred events in a first repository. A simulation unit is configured to receive data from the first repository to predict events and store the predicted events in a second repository. A context unit is configured to receive data from the first and second repositories to determine a global context. A recommendation unit is configured to receive data from the second and third repositories and the global context to determine user recommendations. An interface outputs the user recommendations. In response to local context information of a user, the operation unit is configured to instruct the simulation engine to predict events associated with a current emergency situation and instruct the recommendation unit to determine a recommendation for the user about the current emergency situation based on the predicted events associated with the current emergency.

In an exemplary embodiment of the present invention, the operation unit, the simulation unit, the context unit and the recommendation unit are included in a computer.

In an exemplary embodiment of the present invention, the user recommendations are wirelessly provided to a computing device operable by the user.

In an exemplary embodiment of the present invention, the computing device is a smartphone, tablet computer or wearable device.

In an exemplary embodiment of the present invention, the recommendation is an AR visualization on the computing device.

According to an exemplary embodiment of the present invention, a method of providing AR recommendations includes displaying, on a user's computing device, an AR visualization of at least one current event, at least one predicted event and at least one action recommendation in relation to an emergency situation, and adjusting, on the computing device, the AR visualization based on a new location of the user and new data associated with the emergency situation.

In an exemplary embodiment of the present invention, the method of providing AR recommendations further includes providing, on the computing device, an AR visualization of the at least one predicted event at a future time selected by the user.

### BRIEF DESCRIPTION OF THE DRAWINGS

The above and other features and aspects of the inventive concept will become more apparent by describing in detail exemplary embodiments thereof with reference to the accompanying drawings, in which:

FIG. 1A illustrates a flowchart of a method for providing augmented reality recommendations, according to an exemplary embodiment of the present invention;

FIG. 1B illustrates a flowchart of a method for providing augmented reality recommendations, according to an exemplary embodiment of the present invention;

FIG. 2 illustrates a block diagram of a system for providing augmented reality recommendations, according to an exemplary embodiment of the present invention;

FIG. 3 illustrates a block diagram of a system for providing augmented reality recommendations, according to an exemplary embodiment of the present invention;

FIG. 4 illustrates an augmented reality visualization, according to an exemplary embodiment of the present invention; and

FIG. 5 illustrates an example of a computer system capable of implementing the method and apparatus according to embodiments of the present disclosure.

### DETAILED DESCRIPTION

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In accordance with an exemplary embodiment of the present invention, an Augmented Reality (AR) system and method may be used to provide help to a user during an emergency situation. A brief description of the present invention will now be presented, followed by a more detailed description with reference to the figures.

An emergency situation may be a fire, flood, a blizzard, a cyclone, high winds, or the like. However, emergency situations are not limited thereto. The type of help provided by the AR system and method may be different depending on the type of the user. A user may be a member of the general population, or an emergency respondent such as a police officer, a firefighter, emergency medical services (EMS) personnel including ambulance drivers, doctors, nurses, and the like.

The AR system and method includes an AR application (APP) that runs in a mobile device, for example, a mobile phone, a tablet, or the like, and a server communicatively coupled to the mobile device. The mobile device may be wirelessly connected to the server using, for example, the Internet. The mobile device includes sensors, a camera, a display panel, speakers, a microphone, and a global positioning system (GPS) tracking device. The AR application may include a profile of the user of the application, indicating, for example, whether the user is a member of the general population or an emergency respondent. When the user is an emergency respondent, the user profile includes the type of emergency respondent that the user is, for example, a firefighter, a police officer, or the like.

The AR APP may gather user information data, sensor data, images, video, sound, and GPS data from the mobile device, and may transmit the gathered data to the server.

The server may acquire external data from external data sources, for example, public repositories, citizen reports (e.g., social media data), sensors different from those of the mobile device, and the like. The server may store event data into a database of observed and inferred events and a database of predicted events based on data acquired from the external data sources. The server may also acquire data from the mobile device.

In an emergency situation, the AR application may transmit to the server data including the user profile, sensor data, images, video, sound, and GPS position of the mobile device. The server generates a list of current events (e.g., there is a fire two blocks ahead), a list of predicted events (e.g., the intersection of main street and side street may be blocked in the next twenty minutes due to the fire), and a list of recommendations for the user based on the type of emergency situation, the location of the emergency situation, the type of user receiving the above-described lists of information, the location of the user, and the like. The current events, the predicted events, and the recommendations may be displayed as annotations in a display panel of the mobile device. The recommendations, however, depend on the type of the user and other data about the user collected from the mobile device. For example, when the user is a member of the general population, the recommendations may be to evacuate to a safe location. When the user is an emergency respondent, the recommendations may be to safely approach the emergency location, which routes to take to the emergency location, and the like.

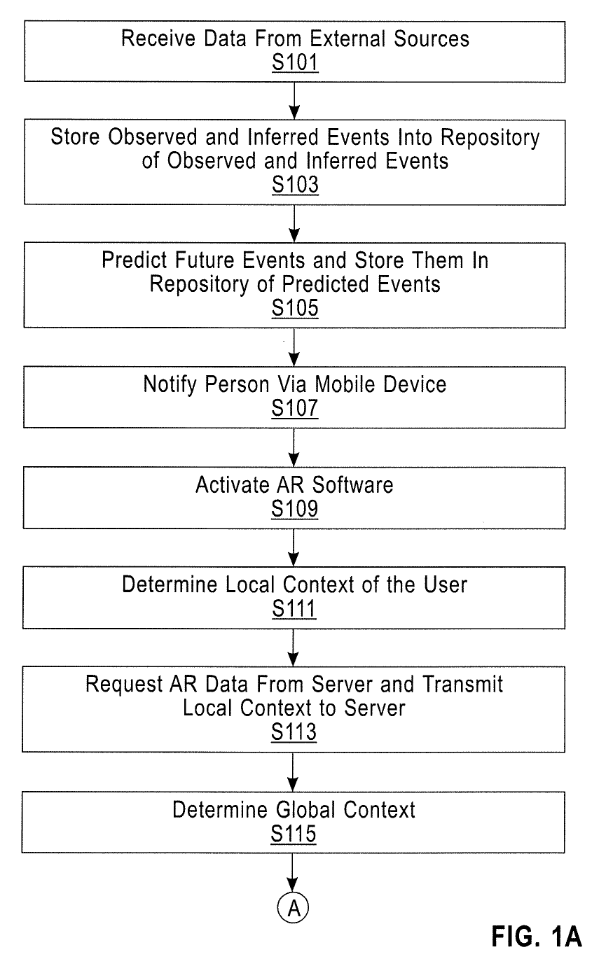

FIGS. 1A and 1B illustrate a flowchart of a method for providing AR recommendations, according to an exemplary embodiment of the present invention.

Referring to FIG, 1A, in step S101, an operation center platform receives data from external sources. The external sources include citizen reports, sensors, agency reports and other external data received from external data repositories. The external data received in step S101 excludes data received from a person's (e.g., user's) mobile device. The data received from the user's mobile device will be described in detail below. The operation center platform may be included in a server.

The citizen reports may include information obtained from social media, for example, where an individual writes (e.g., posts information on social media) that he or she saw a wildfire spread across a particular region. Citizen reports may also be submitted through a special purpose application with express purpose of providing information on the state of the situation. The sensors may include fire sensors, smoke sensors, flood/water sensors, light sensors, GPS sensors, temperature sensors, humidity sensors, vibration sensors, gyroscopes, accelerometers, and the like. The agencies may include government agencies, news agencies, and the like, reporting a current status of an emergency. The external data repositories may include information about historic emergency situations, including data such as the type of emergency, when it occurred, the damage caused by the emergency, costs to bring the emergency situation under control, costs associated with repairing the damage caused by the emergency situation, other effects of the emergency situation, and the like.

In step S103, observed and inferred events, based on the data received in step S101 and data obtained from the user's mobile device, are stored into a repository of observed and inferred events. The repository of observed and inferred events is communicatively coupled with the operation center platform. The observed and inferred events may also be referred to as current events. The repository of observed and inferred events includes a collection of descriptions of current events (e.g., emergency situations) of the real-world. Each event included in the repository of observed and inferred events is represented by a tuple<time, which is less than or equal to a current time, a location of the event including geolocation (e.g., geographical) coordinates, a certainty level which describes a level of confidence (e.g., [0 . . . 1]) of an observed or inferred event, a type of event which includes a description of the event (e.g., flood, fire, road block, and the like), and parameter details of the event which include a description of the severity of the event (e.g., low, mild, severe, and the like)>. For each event, the type of event, parameter details of the event, and geographical coordinates of the event may be obtained from the external data received in step S101 and data obtained from the user's mobile device. Events obtained from different sources that describe a same physical phenomenon may be conflicting or partially conflicting.

In an exemplary embodiment of the present invention, the level of confidence of each event may be determined based on a credibility of the source of information describing an event and/or by comparing event data describing the same event obtained from other sources. An inferred event may be an event that is logically deduced from an observed event.

In step S105, future events are predicted using a situation simulation engine. The situation simulation engine may be a computer program that runs in a computer such as a server. The situation simulation engine is a simulator that predicts (e.g., models) how an emergency situation may progress given a type of emergency, tuple data regarding the emergency situation, the location of the emergency, and the features (e.g., persons, buildings, roads, land type, topography, and the like) existing at the location of the emergency and within a certain radius of the location of the emergency. In addition, the situation simulation engine models effects of the emergency situation, for example, effects such as population migration caused by the emergency situation, vehicular and pedestrian traffic caused by the population migration, and the like. The situation simulation engine models damage occurring during the emergency situation. In other words, the situation simulation engine models how a given emergency situation may evolve and what the consequences of the emergency situation may be. The situation simulation engine may model any type of emergency situation. The types of emergency situations described below are merely exemplary. The emergency situations may include fire, flood, snowfall, cyclones, earthquakes, and the like.

The situation simulation engine takes as input the type of emergency situation and physical features and objects existing at the emergency area and in a given radius from the emergency area. The situation simulation engine includes models that predict how a change in one or more of the input features and objects, or an introduction or removal of an additional of a feature or object, affects other features, objects, and/or people, for a predetermined amount of time in the future. The features and objects may be elements of the world, for example, a tract of land and its topography and vegetation, for example, bushy wild land with a relatively flat surface, a river including the river's profile and cross-sections, buildings, roads, and the like.

The future events predicted by the situation simulation engine are stored into a repository of predicted events. The future events may also be referred to as predicted events. The situation simulation engine may predict future events by simulating input data including the external data obtained in step S101 and the data stored in the repository of observed and inferred events.

Each event stored in the repository of predicted events is represented by a tuple<time, which is greater than the current time, a location of the predicted event including geolocation (e.g., geographical) coordinates, a certainty level which describes a level of confidence (e.g., [0 . . . 1]) of the predicted event, the type of the predicted event which includes a description of the predicted event (e.g., flood, fire, road block, and the like), and parameter details of the predicted event which include a description of the severity of the event (e.g., low, mild, severe, and the like)>.

In an exemplary embodiment of the present invention, during, for example, a fire emergency, the situation simulation engine may use a tuple of data including a topography of a land where the fire is burning and a topography of the land surrounding the fire, a climate of the area where the fire is located, vegetation of the area surrounding the fire, wind speed and direction at the location of the fire, and the like, to predict how, where, and when the fire may advance. The situation simulation engine may predict (e.g., simulate) a location where the fire may spread at different points in time during a predetermined future time span. For example, the situation simulation engine may simulate the fire reaching a point five miles away from a particular town in two hours from the current time, and that the fire may reach an outskirt of the particular town in three hours from the current time.

The situation simulation engine may include simulation software for example, fire simulators including FARSITE, PHOENIX RAPIDFIRE, and the like, hydrology and hydraulics simulators including TECHNICAL RELEASE NO. 20 (TR-20) COMPUTER PROGRAM FOR PROJECT FORMULATION HYDROLOGY, STORMCAD, HYDROCAD, and the like, and other simulators. FARSITE and PHOENIX RAPIDFIRE can be used to simulate wildfires using the external data obtained in step S101, and the data stored in the repository of observed inferred events. The hydrology and hydraulics simulators can be used to determine flood from rainwater accumulation, river bank breach, coastal floods, and the like, using the external data obtained in step S101, and the data stored in the repository of observed inferred events. The hydrology and hydraulics simulators described above may simulate storm water drainage systems performance, road flooding, river bank breaching, pond water level, and the like, at different points in time for a predetermined future time span. The simulation software may be referred to as models of the world.

In step S107, a person (e.g., user) is notified via a mobile device that an emergency situation is in progress. The mobile device may be a wireless phone, a tablet computer, a wearable mobile device such as AR glasses or a smart watch, or the like.

In step S109, the user activates (e.g., runs) an AR APP on the mobile device.

In step S111, the local context of the user is determined by a local context module included in the AR APP running in the user's mobile device. The local context includes any information relevant to a particular user at the current time. The local context includes, for example, data stored in the user's mobile device (e.g., a user profile) or voice commands given by the user (e.g., I want to go pick up my kids). The local context includes the location of the user but may also include an intention of the user at the current time (e.g., the user wants to pick up his/her kids, instead of wanting to evacuate due to the current emergency situation). The local context may be generated by the local context module of the AR APP by retrieving information from the user's calendar, profile information (e.g., user profile), notes, and the like, stored in the user's mobile device. The user profile may include data indicating whether the user is a member of the general public or an emergency respondent, the user's address, telephone number, age, and the like. In addition, the local context may include sensor data obtained from the user's mobile device. The sensor data obtained from the user's mobile device may include, for example, GPS data, gyroscope data, accelerometer data, temperature data, real-time image data, sound data, and the like.

In step S113, the AR APP transmits a request for AR data from the server. In addition, in step S113, the AR APP transmits the local context to the server. The local context may be stored in the repository of observed and inferred events and may be used by the situation simulation engine to predict future events stored in the repository of predicted events.

In step S115, a global context is determined by using a context engine. The global context is a single unified version of the world (e.g., the events stored in the above-mentioned repositories, whether consistent and/or inconsistent, are combined to create one consistent version of the world). The context engine may be a computer program running in the server that may create a simulated single, consistent, version of the world that may include a current emergency event and a current status of objects and features of the world. In determining the global context, the context engine accesses and processes the data stored in the repository of observed and inferred events and the repository of predicted events. To determine the global context, the context engine runs algorithms, for example, matching algorithms, to classify and correlate the provided local context with the information stored in the repository of observed and inferred events and the repository of predicted events. Since some events stored in the repository of observed and inferred events and the repository of predicted events may be inconsistent, the confidence level of each event is used in determining the single unified version of the world.

For example, when a first event stored in the repository of observed and inferred events, along with its tuple including its confidence level and time, indicates that a fire is at a first location, and a second event stored in the repository of observed and inferred events, along with its tuple including its confidence level and time, indicates that the fire is at a second location, the context engine may determine the fire event to be a fire located at the first location, the second location, or somewhere in between the first and second locations. This may be done using the tuple data of each event. In addition, if the times of each event are different, a time of the event (e.g., the fire) will be decided for the event when generating the global context.

In an exemplary embodiment of the present invention, the global context may include information such as, for example, in Town A, Road B is blocked and that a fire is burning in the periphery of Town A and approaching Town A from the West.

In an exemplary embodiment of the present invention, the global context may include information such as, for example, current rainfall amount is 3 inches per hour, the banks of River C have been breached, and the water flowing in River C has flooded Town D, (e.g., River C passes through Town D).

Referring to FIG. 1B, in step S117, a set of recommended actions for the user to take in an emergency situation is determined. The set of recommendations is determined for the particular user receiving the recommendations, and include recommendations applicable to a location (e.g., coordinates) where the user is located and to an area surrounding the location of the user. The location of the user may be determined by triangulating the location of the user's mobile device or by GPS data provided by the user's mobile device.

In an exemplary embodiment of the present invention, when there are a plurality of users, the set of recommendations are determined for each individual user.

The set of recommendations of actions for a particular user to take is determined based on the global context determined in step S115, the local context determined in step S111, the events stored in the repository observed and inferred events determined in step S103, and the events stored in the repository of predicted events in step S105.

In an exemplary embodiment of the present invention, when the local context of a user indicates that the user is a member of the general public, the set of recommendations for the user may include evacuation instructions including recommended evacuation routes for the user to take to get to a safe location.

In an exemplary embodiment of the present invention, when the local context of a user indicates, for example, that the user intends to pick his his/her kids from school, the set of recommendations for the user may include one or more recommended routes for the user to take to get to the school within a reasonable amount of time, or as soon as possible. The one or more recommended routes may be determined using the global context, which may indicate street closures due to, for example, a fire causing an emergency situation, the data stored in the repository of predicted events, which may indicate, for example, that the fire is predicted to burn the western part of town in the next two hours, and additional road closures and traffic congestions predicted for the next two hours due to the emergency situation. In this case, when it is determined by the local context that the user intends, for example, to pick up his/her kids from school, the set of recommendations will not recommend to the user to leave his/her kids in school (e.g., not pick them up) and evacuate without them.

In an exemplary embodiment of the present invention, when the local context of a user indicates that the user is an emergency respondent, the set of recommendations for the user may include recommended routes for the user to take to get to the emergency location quickly, and recommended actions for the user to take to bring the emergency situation under control.

For example, in an exemplary embodiment of the present invention, when the user is a firefighter (e.g., indicated in the user's local context), the set of recommendations may include recommended routes for the user to take to bring a fire truck or a fire-extinguishing aircraft at the site of a fire to extinguish the fire. In addition, the recommendations may include fire-extinguishing techniques for extinguishing the fire and/or preventing the fire from spreading to areas where it may cause extensive damage (e.g., when the fire cannot be immediately extinguished, trees, structures, buildings, storage warehouses, and the like, that are located in a predicted path of the fire may be destroyed before the fire reaches them to prevent the fire from spreading).

In an exemplary embodiment of the present invention, local context data is continuously transmitted to the server by the AR APP. For example, during the continuous transmittal of local context data, a second set of local context data may include, for example, the user's observation regarding current level of flood at the user's location, the user's indication that the fire has or has not reached a location that the user is observing at the time of the observation, and the like. For example, the user may indicate that a fire has not reached a hilltop at the time that the user observed the hilltop. When stored in the observed and inferred events repository, the second set of local context data may include tuple<time, which is less than or equal to a current time, a location of the event geographical coordinates, a certainty level which describes a level of confidence (e.g., [0 . . . 1]) of the event, a type of event which includes a description of the event (e.g., flood, fire, road block, and the like), and parameter details of the event which include a description of the severity of the event (e.g., low, mild, severe, and the like)>, data for each event observed by the user. The second set of local context data may be used an input in changing, altering, or modifying the predicted future events, which are predicted using the situation simulation engine in step S105. The changed, altered, or modified future predicted events may be used to modify the global context and the set of recommendations transmitted to all users of the method for providing AR recommendations. It should be understood that the sets of recommendations described above are merely exemplary.

In step S119, the global context determined in step S115 and the set of recommendations determined in step S117 are packed together.

In step S121, the packed global context and the set of recommendations are transmitted to the AR APP running on the mobile device. Since the server which transmits the packed context and the set of recommendations is communicatively coupled with the mobile device running the AR APP, the transmission may be done wirelessly, for example, via the Internet.

In step S123, the AR APP displays at least one AR visualization of a current event, at least one AR visualization of a predicted event, and at least one AR visualization of an action recommendation in relation to the emergency situation, using the packed global context and the set of recommendations. A visualization of a current event may be an image including figures, lines, text, and the like, that indicates and describes a current (e.g., real time) emergency event occurring in the region surrounding the mobile device. For example, a visualization of a current event may be an image including a box having a first color and text, for example “road block ahead,” and/or “fire happening in this direction”, with arrows pointed to where the road block and/or the fire is located as superimposed on an a map of the area where the mobile device is located or a real-time image displayed on the screen of the mobile device.

A visualization of a predicted event may be an image including figures, lines, text, and the like, that indicates and describes a predicted emergency event occurring in the region surrounding the mobile device. The predicted event may be, for example, that Road F, which is located in the vicinity of the user, is predicted to be congested in 20 minutes. The visualization of the predicted event may include, for example, a box having a second color and text, for example, “this road will be congested in 20 minutes”, and an arrow pointing to Road F on the screen of the mobile device. The second color may be different from the first color.

A visualization of a recommended action may be an image including figures, lines, text, and the like, that indicates and describes a recommended course of action for the user to take. The visualization of the recommended action may include, for example, a box having a third color and text, for example, “use escape route through this way”, and an arrow pointing to the escape route on the screen of the mobile device. The third color may be different from the first and second colors.

The AR visualization of the at least one current event, the at least one predicted event, and the at least one action recommendation may be overlaid on an image (e.g., map, real-time image obtained by the mobile device's camera) displayed on a two-dimensional screen of the mobile device.

According to an exemplary embodiment of the present invention, the AR visualizations of current events, predicted events, and recommended actions, may be illustrated in perspective view on the screen of the mobile device. The AR visualizations of current events, predicted events, and recommended actions may be overlaid on the real-time image of the mobile device and may correspond to the objects and features shown in the real-time image.

In an exemplary embodiment of the present invention, since events are predicted for a given time span in the future, and recommendations are determined for a given time span in the future, the user may fast-forward, or preview, the predicted events and the recommendations at discrete moments (e.g., times) for the entire time span for which they are determined. For example, the user may fast-forward, or change the current time to a future time to view what events are predicted to occur and what recommendations may be offered at the fast-forwarded future time.

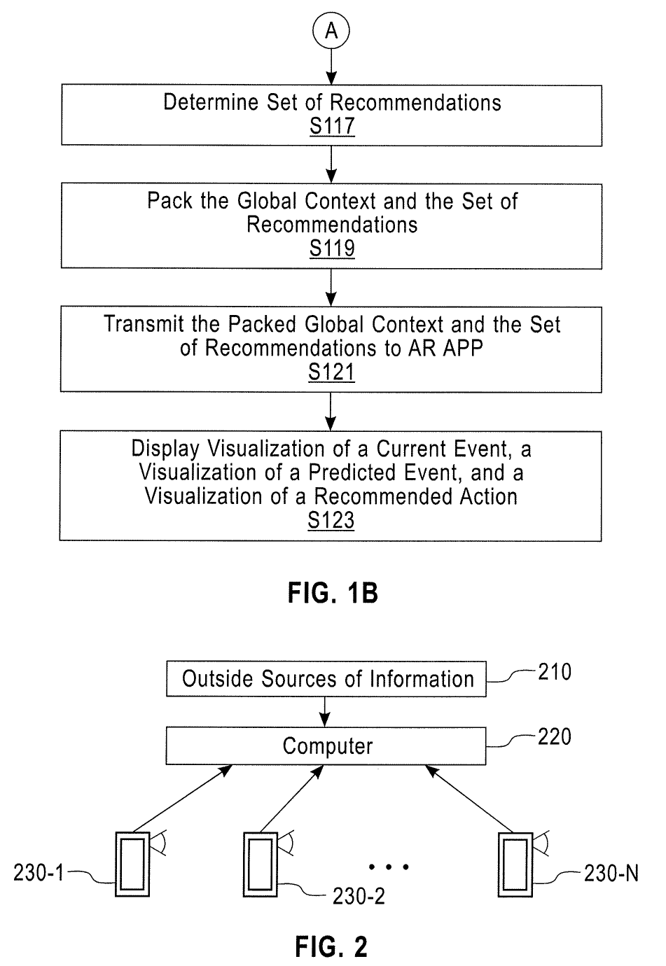

FIG. 2 illustrates a block diagram of a system for providing AR recommendations, according to an exemplary embodiment of the present invention.

Referring to FIG. 2, the system for proving AR recommendations includes outside sources of information 210, a computer 220, and a plurality of mobile devices 230-1 and 230-2 to 230-N (e.g., N is a positive non-zero integer). The system for proving AR recommendations illustrated in FIG. 2 may be used to perform the steps of the method for proving AR recommendations described with reference to FIGS. 1A and 1B above.

The outside sources of information 210 may correspond to the external data sources of described with reference to FIG. 1A. The outside sources of information 210 are communicatively coupled to the computer 220 and may continuously transfer data to the computer 220. The outside sources of information 210 include citizen reports, sensors, agency reports and external data repositories. The citizen reports include social media websites. The sensors include fire sensors, smoke sensors, flood/water sensors, light sensors, GPS sensors, temperature sensors, humidity sensors, pressure sensors, vibration sensors, gyroscopes, accelerometers, and the like. The agency reports may include news publications, government publications, and the like. In addition, the outside sources of information 210 may include public and/or private repositories containing historical information. Data obtained from the outside sources of information 210 may include descriptions of current events, including emergency events, and descriptions of objects and features of the real world, as described with reference to FIGS. 1A and 1B.

The computer 220 may be a server or other computing device communicatively coupled with the sources of information 210 and each of the mobile devices 230-1 to 230-N. The computer 220 may continuously transmit information to each of the mobile devices 230-1 to 230-N. In addition, the computer 230 may continuously receive information from each of the mobile devices 230-1 to 230-N.

The computer 220 may determine a current event, for example, an emergency event, and use descriptions of objects and features of the real world obtained from the outside sources of information 210 and the mobile devices 230-1 to 230-N to provide the individual users of the mobile devices 230-1 to 230-N, respectively, with visualizations of current events, predicted events, and recommended actions during the emergency event. The visualizations are graphical indicators indicating features and objects, persons, current events, predicted events, and recommended courses of action using text, geometrical shapes, lines, arrows, and the like.

The computer 220 may transmit current events, predicted events, and recommended actions to each of the mobile devices 230-1 to 230-N. It is to be understood that a plurality of mobile devices 230-1 to 230-N are exemplarily illustrated.

In an exemplary embodiment of the present invention, the system for proving AR recommendations includes only one mobile device, for example, the mobile device 230-1. Accordingly, in an exemplary embodiment of the present invention, the system for providing AR recommendations includes the outside sources of information 210, the computer 220, and the mobile device 230-1.

Each of the plurality of mobile devices 230-1 to 230-N may be a mobile phone, a tablet computer, a laptop computer, AR glasses, a smart watch, or the like. Each of the plurality of mobile devices 230-1 to 230-N may be communicatively coupled to the computer 220, for example, via the Internet or other wireless communication protocol. Accordingly, each of the plurality of mobile devices 230-1 to 230-N may continuously transfer data to, and receive data from, the computer 220.

According to an exemplary embodiment of the present invention, each of the mobile phone, tablet computer, laptop computer, and smart watch may include a display panel, a camera, a microphone, a speaker, a GPS tracking device, an accelerometer, motion detection sensors, a temperature sensor, a scent sensor, a pressure sensor, and the like. Each of the mobile phone, tablet computer, laptop computer, and smart watch, respectively, may run the AR APP that performs the method steps of the method illustrated with reference to FIGS. 1A and 1B. The current events, the predicted events, and the recommended actions may be overlaid as visualizations including descriptions of features and objects, persons, current events, predicted events, and recommended courses of action using text, geometrical shapes, lines, arrows, and the like, on the display panel of the mobile phone, the tablet computer, and the laptop computer, respectively. The current events, the predicted events, and the recommended actions may be illustrated in perspective view and may correspond to real-time image data obtained by the camera of each respective device (e.g., the mobile phone, the tablet computer, and the laptop computer). In addition, each of the mobile phone, tablet computer, laptop computer, and smart watch may include a touch-sensitive display panel through which the user may interact with the AR app by touching the touch-sensitive display panel. For example, the user may request additional AR information such as recommended courses of actions by touching particular areas of the display. A user profile indicating whether the user is a member of the public or an emergency respondent, among other data describing the user as described with reference to FIGS. 1A and 1B above, may be stored in a computer of the AR glasses and may be wirelessly transferred to the computer 220.

AR glasses may be glasses worn by a user. According to an exemplary embodiment of the present invention, the AR glasses may include glass or plastic lenses disposed in front of a user's eyes and attached to a frame worn by the user. The AR glasses may include a computer attached to the frame of the glasses that is communicatively coupled with the computer 220. A user profile indicating whether the user is a member of the public or an emergency respondent, among other data describing the user as described with reference to FIGS. 1A and 1B above, may be stored in the computer of the AR glasses and may be transferred to the computer 220. The AR glasses may include a projector that can overlay AR information (e.g., the current events, the predicted events, and the recommended actions) on the lenses. In addition, the AR glasses may include a GPS tracking device, an accelerometer, motion detection sensors, a camera, a microphone, a speaker, light sensors, a temperature sensor, a scent sensor, a pressure sensor, and the like. The computer of the AR glasses may continuously retrieve data from the GPS tracking device, the accelerometer, the motion detection sensors, the camera, the microphone, the speaker, the light sensors, the temperature sensor, the scent sensor and the pressure sensor. The AR glass can detect a direction along which the glasses are aligned and can project visualizations of current events, predicted events, and recommended actions on the lenses for the user of the AR glasses to view, according to the features and objects that exist in the direction in which the AR glasses are aligned.

The visualizations may be overlaid on the lenses of the AR glasses to correspond to objects and features that the user sees through the AR glass lenses. For example, the user may view an intersection of two roads through the AR glass lenses. A visualization of a recommendation may include text indicating the name of each road, with arrows pointing to the corresponding road. Alternatively, the text including the road name overlaid along the direction of the road. Recommendations on which road to evacuate through, labeling the evacuation route and including guidance arrows indicating the evacuation route may be overlaid on the AR glass lenses to appear as superimposed on the user's view. In addition, a button that can be depressed or slid may be disposed on the frame of the AR glasses. The projection of the current events, predicted events, and recommended actions on the lenses of the AR glasses may be disabled or enabled by depressing or sliding the button.

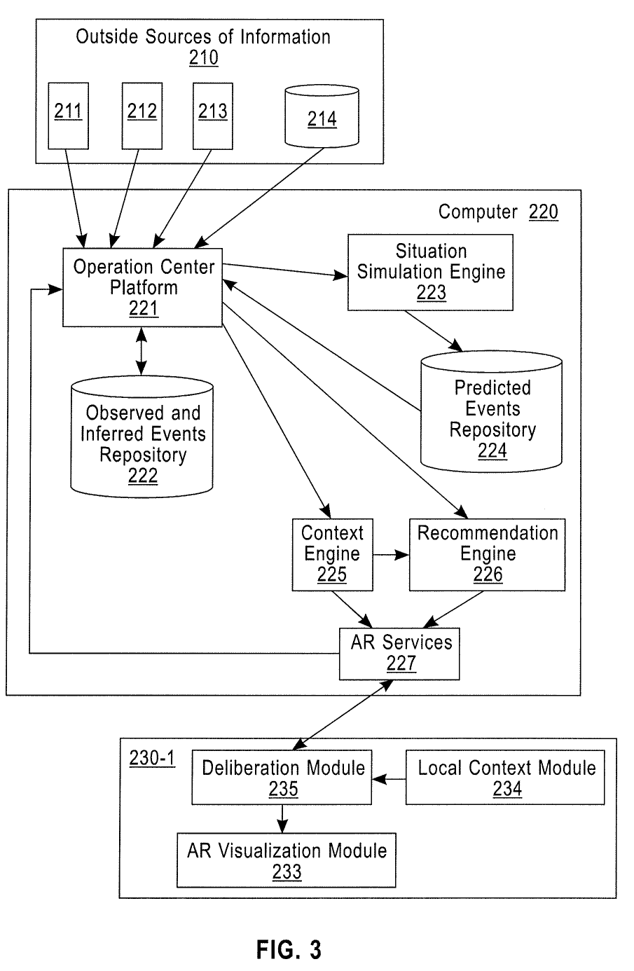

FIG. 3 illustrates a block diagram of a system for providing AR recommendations, according to an exemplary embodiment of the present invention.

Referring to FIG. 3, the system for proving AR recommendations includes the outside sources of information 210, the computer 220, and the mobile device 230-1. The system for proving AR recommendations illustrated in FIG. 3 may be used to perform the steps of the method for providing AR visualizations described with reference to FIGS. 1A and 1B above.

The outside sources of information 210 includes citizen reports 211, sensors 212, agencies 213, and external data sources 214. The citizen reports 211 include the social media sites as described with reference to FIG. 2. The sensors 211 include fire sensors, smoke sensors, flood/water sensors, light sensors, GPS sensors, temperature sensors, humidity sensors, pressure sensors, vibration sensors, gyroscopes, accelerometers, and the like. The agencies 213 include news and government publications as described with reference to FIG. 2. The external data sources 214 include repositories containing historical information (e.g., historical emergency situation information), as described with reference to FIGS. 1A, 1B, and 2.

The citizen reports 211, sensors 212, agencies 213, and external data sources 214 are communicatively coupled with the computer 220 and transmit data including descriptions of the real world to an operation center platform 221 of the computer 220. In addition, the citizen reports 211, sensors 212, agencies 213, and external data sources 214 may transmit emergency situation data (e.g., a fire occurring on Road A) to the operation center platform 211. The data transmitted by the citizen reports 211, sensors 212, agencies 213, and external data sources 214 to the operation center platform 221 may correspond to the data received from external sources in step S101 of FIG. 1.

The computer 220 includes the operation center platform 221, an observed and inferred events repository 222, a situation simulation engine 223, a predicted events repository 224, a context engine 225, a recommendation engine 226, and an AR services 227.

The operation center platform 221 processes the data received from the citizen reports 211, sensors 212, agencies 213, and external data sources 214 to determine observed and inferred events, and associates each observed and inferred event with its correspondent tuple, as described in step S103 of the method for providing AR recommendations described with reference to FIGS. 1A and 1B. Each inferred and observed event is stored in the observed and inferred events repository 222.

The situation simulation engine 223 may correspond to the situation simulation engine described with reference to the method for providing AR recommendations described above. The situation simulation engine 223 may receive input data from the observed and inferred events repository 222 and the operation center platform 221 to predict a set of events and their respective tuple of data as described with reference to step S105 of FIG. 1A. The situation simulation engine 223 stores the predicted events, associated with their tuple, in the predicted events repository 224. The predicted events repository 224 may transfer the predicted events stored therein to the operation center platform 221.

The context engine 225 takes as input data from the observed and inferred events repository 222 and the predicted events repository 224 through the operation center platform 221 to determine a global context, as described with reference to step S115 of FIG. 1A.

The recommendation engine 226 takes as input data stored in the observed and inferred events repository 222 and the predicted events repository 224 through the operation center platform 221. In addition, the recommendation engine 226 takes as input the global context determined by the context engine 225. The recommendation engine 226 processes the input data to determine a set of recommended actions for a user to take in an emergency situation, as described in step S117 of FIG. 1B.

The AR services 227 packs together the global context determined by the context engine 225 and the set of recommended actions determined by the recommendation engine 226 and sends the packed data to a deliberation module 235 of the mobile device 230-1. The packing of the global context and set of recommended actions may correspond to actions performed in step S119 of the method described with reference to FIGS. 1A and 1B. In addition, the AR services 227 receives data from the deliberation module 235 of the mobile device 230-1, the data including a request for AR information from the mobile device and the local context determined by the local context module 234 of the mobile device 230-1. The AR services 227 may continuously transmit the received data from the mobile device 230-1 to the operation center platform 221 for processing. For example, events that the user of the mobile device 230-1 observes (e.g., the fire has not reached the hilltop yet) may be stored in the observed and inferred events repository 222, and may be used by the situation simulation engine 223 to revise the predicted events stored in the predicted events repository 224. Accordingly, the user's observation may be used by the context engine 225 to revise the global context and by the recommendation engine 226 to revise the recommended actions for the user to take.

The mobile device 230-1 may be a mobile phone, a tablet computer, a laptop computer, AR glasses, a smart watch, or the like, as described above.

The mobile device 230-1 may run the AR APP which performs the method steps of the method described with reference to FIGS. 1A and 1B. The AR APP includes an AR visualization module 233, the local context module 234, and the deliberation module 235.

The local context module 234 determines the local context of the user by using the user's voice commands, real-time image data received from the mobile device's 230-1 camera, and scent data, GPS data, temperature data, humidity data, pressure data, vibration data, gyroscope data, and acceleration data obtained by the mobile device's 230-1, scent sensor, GPS sensor, temperature sensor, humidity sensor, pressure sensor, vibration sensor, gyroscope, and accelerometer, respectively. In addition, the local context module 234 may use data stored in the mobile device 230-1, for example, the user's text notes, calendar events, and user profile, to determine the local context. The local context determined by the context module 234 may correspond to the local context of the user determined in step S111 of the method for proving AR recommendations described with reference to FIGS. 1A and 1B. In addition, the local context module 234 can track and identify objects and features of objects shown in a real-time image captures by the mobile device's 203-1 camera, and may transfer the tracked and identified objects and features to the computer 220 so that the tracked and identified objects can be considered in determining and/or revising the global context and the set of recommendations for the user.

The deliberation module 235 transmits the request for AR information to the AR services 227, as described above. In addition, the deliberation module 235 transmits the local context and data used by the local context module 234 to the AR services 227. The deliberation module 235 receives the packed data from the AR services 227, as described above, ranks the received data, and selects the most relevant (e.g., highly ranked) AR information to be displayed to the user by considering the user's local context.

The AR visualization module 233 receives the selected information for display by the deliberation module 235 and compiles the AR visualization. The AR visualization may include a graphical visualization of a current event, a graphical visualization of a predicted event, and a graphical visualization of a recommended action, as described with reference to step S123 of the method for providing AR recommendations illustrated with reference to FIGS. 1A and 1B.

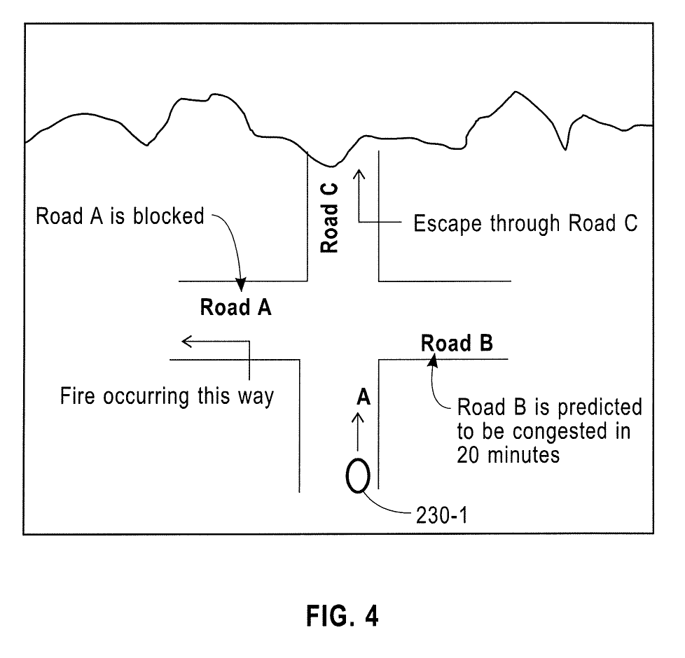

It is understood that a plurality of mobile devices can be used with the system for providing augmented reality recommendation described with reference to FIG. 4. Each of the plurality of mobile devices can be wirelessly connected with the computer 220 via, for example, the Internet. The system for providing augmented reality recommendation of FIG. 4 may provide different recommendations to different users depending on each respective user's local context, and the data used to generate the user's local context (e.g., the user profile, location, mobile device sensor data, and other data stored in the user's mobile device).

FIG. 4 illustrates an AR visualization, according to an exemplary embodiment of the present invention. The AR visualization may be superimposed (e.g., overlaid) in perspective view or plan view on an image displayed on the display panel of the mobile device 230-1, described with reference to FIG. 3. Referring to FIG. 4, a four dimensional AR visualization includes a first dimension including a map or a real-time image of the area surrounding the mobile device 230-1. As illustrated in FIG. 4, the AR visualization illustrates a map of an intersection, a location where the mobile device 230-1 is disposed, and a direction “A” in which the mobile device 230-1 is directed toward. The intersection includes features and objects, for example, “Road A”, “Road B”, and “Road C”.

A second dimension of the AR visualization includes, for example, a visualization of a current events. As illustrated in FIG. 4, the visualization of a first current event includes the text “Road A is blocked” and an arrow pointing to “Road A”. In addition, in FIG. 4, a visualization of a second current event includes the text “Fire occurring this way” and an arrow pointing to the direction in which the fire is occurring. The visualization of the current events may be displayed in a first color, for example, a red color. According to an exemplary embodiment of the present invention, a visualization of current events may include only one current event.

A third dimension of the AR visualization includes, for example, a visualization of a predicted event. As illustrated in FIG. 4, the visualization of the predicted event includes the text “Road B is predicted to be congested in 20 minutes” and an arrow pointing to “Road B”. The visualization of the current event may be displayed in a second color, for example, a blue color.

A fourth dimension of the AR visualization includes, for example, a visualization of a recommended course of action. As illustrated in FIG. 4, the visualization of the recommended course of action includes the text “Escape through Road C” and an arrow pointing to “Road C”. The visualization of the current event may be displayed in a third color, for example, a green color.

However, exemplary embodiments are not limited to the above-described visualizations. For example, an AR visualization, according to an exemplary embodiment of the present invention, includes one or more visualizations of current events, one or more visualizations of predicted events, and one or more visualizations of recommended courses of action.

In an exemplary embodiment of the present invention, the user may tap the display panel of the mobile device 230-1 to fast-forward the current time to view what events are predicted to occur in discrete moments the future and what courses of action may be recommended in the future. In an exemplary embodiment of the present invention, the user may fast-forward the current time by a voice command. When the mobile device 230-1 is the AR glasses, the user may fast-forward the current time by sliding a slider disposed on the frame of the AR glasses or by a voice command.

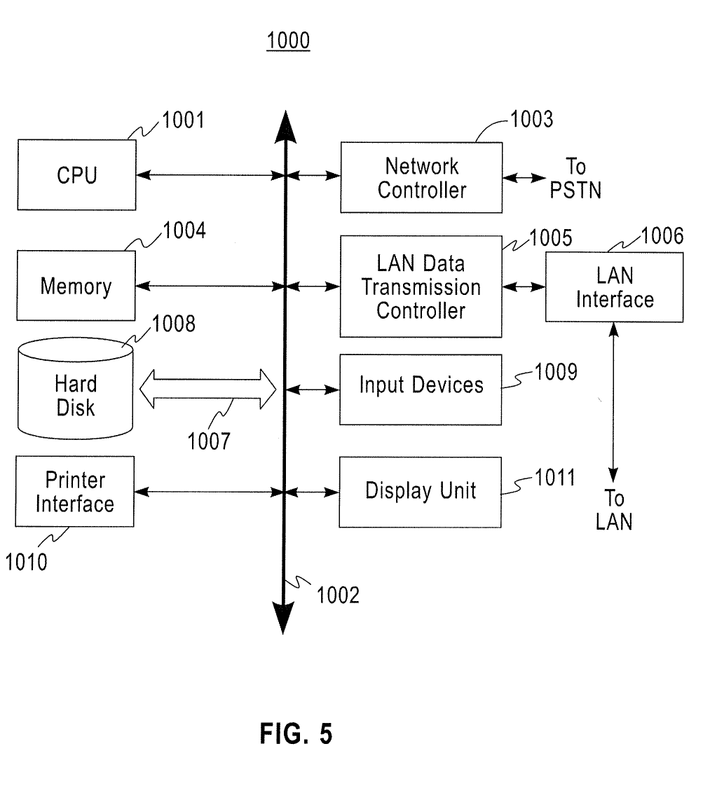

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of providing augmented reality recommendations, comprising:
notifying a user about an emergency situation, wherein the notification is provided to the user via a mobile device; and
activating a software application on the mobile device to provide an augmented reality (AR) visualization of at least one current event, at least one predicted event and at least one action recommendation in relation to the emergency situation.

2. The method of claim 1, wherein the AR visualization is provided on top of a four-dimensional view of an area around the user.

3. The method of claim 1, wherein the mobile device includes a smartphone or a wearable device.

4. The method of claim 1, wherein in response to activating the software application, the method further comprises:
requesting a remote AR service to provide information including:
observed and inferred events;
predicted events in the area;
global context; and
recommendations.

5. The method of claim 4, wherein the observed and inferred events are included in a repository of observed and inferred events, the repository including a set of events collected from other sources or analytical models, wherein each event is represented by tuple time≦current time, geolocation coordinates, prediction level confidence, event type and degree.

6. The method of claim 5, wherein the predicted events in the area are included in a repository of predicted events, the repository including a set of future events computed by a situation simulator, wherein each event is represented by a tuple<time, location, certainty, type, parameters>, where time is greater than current time, location is geolocation coordinates, certainty is the prediction level confidence, type is the event type and degree.

7. The method of claim 6, wherein the situation simulator infers the set of future events based on computation guided by models of the world and the set of events in the repository of observed and inferred events.

8. The method of claim 6, wherein a context engine computes the global context based on a local context included in the request, the global context including a set of related and predicted events in the area near the user.

9. The method of claim 8, wherein a recommendation engine computes the recommendations based on the local context and the global context, data from the repository of observed and inferred events and data from the repository of predicted events.

10. The method of claim 9, wherein the recommendations includes a set of recommendations for best actions in the area near the user.

11. The method of claim 1, wherein the action recommendation includes route guidance to a location of the emergency situation, or route guidance to a location away of the emergency situation.

12. The method of claim 11, wherein the action recommendation is based on a local context of the user.

13. The method of claim 12, wherein the local context is determined personal information of the user obtained from the mobile device.

14. A system for providing augmented reality recommendations, comprising:
an operation unit configured to receive data from external sources to determine observed and inferred events and store the observed and inferred events in a first repository;
a simulation unit configured to receive data from the first repository to predict events and store the predicted events in a second repository;
a context unit configured to receive data from the first and second repositories to determine a global context;
a recommendation unit configured to receive data from the second and third repositories and the global context to determine user recommendations; and
an interface for outputting the user recommendations,
wherein in response to local context information of a user, the operation unit is configured to instruct the simulation engine to predict events associated with a current emergency situation and instruct the recommendation unit to determine a recommendation for the user about the current emergency situation based on the predicted events associated with the current emergency.

15. The system of claim 14, wherein the operation unit, the simulation unit, the context unit and the recommendation unit are included in a computer.

16. The system of claim 14, wherein the user recommendations are wirelessly provided to a computing device operable by the user.

17. The system of claim 16, wherein the computing device is a smartphone, tablet computer or wearable device.

18. The system of claim 16, wherein the recommendation is an augmented reality visualization on the computing device.

19. A method of providing augmented reality recommendations, comprising:
displaying, on a user's computing device, an augmented reality (AR) visualization of at least one current event, at least one predicted event and at least one action recommendation in relation to an emergency situation; and
adjusting, on the computing device, the AR visualization based on a new location of the user and new data associated with the emergency situation.

20. The method of claim 19, further comprising:
providing, on the computing device, an AR visualization of the at least one predicted event at a future time selected by the user.
